(19) United States
(12) Patent Application Publication
(10) Pub. No.: US 2023/0030919 A1
(43) Pub. Date: Feb. 2, 2023

(54) CONNECTION DEVICE FOR THE CHARGING OF ELECTRIC WHEELCHAIRS

(71) Applicant: ENEL X CHARGE S.r.l., Rome (IT)

(72) Inventors: Alessio PACE, Rome (IT); Lorenzo RAMBALDI, Rome (IT); Tiziano VALENTINETTI, Rome (IT)

(21) Appl. No.: 17/790,034

(22) PCT Filed: Dec. 31, 2019
(86) PCT No.: PCT/IT2019/000124

§ 371 Date: Jun. 29, 2022

(51) Int. Cl. B60L 53/18; B60L 53/16; H02H 7/22; A61G 5/04

(52) U.S. Cl. CPC B60L 53/18; B60L 53/16; H02H 7/226; A61G 5/04; B60L 2200/34

(57) ABSTRACT

The present invention refers to a connection device installed on-board with respect to an electric wheelchair, designed and configured to allow the charging of a respective traction battery using a charge station or column for electric vehicles which implements the mode 3 of charging compliant with the IEC 61851-1 standard. The connection device attached to the wheelchair comprises a main body configured to be connected to a first wire portion for the electrical connection to the charge station. The main body further comprises an electrical circuit configured to simulate the performance of an electric vehicle and defined compliant with the IEC 61851-1 standard, edition 3, Annex 1, chapter A.2.3.

### TECHNICAL FIELD OF THE INVENTION

The present invention refers to a connection device installed on-board with respect to an electric wheelchair designed and configured to allow the respective traction battery to be recharged by means of a charging station or column for electric vehicles that implements the mode 3 of charging according to IEC 61851-1.

### BACKGROUND

At present, it is estimated that people with an impairment such as to require the greater or lesser permanent use of a wheelchair are about 75 million worldwide, whose 7 million in the USA and 5 million in Europe. Referring only to Italy, the most recent estimates indicate that there are more than 3 million people affected by such an impairment, with an age distribution that mainly involves the population over 70.

Furthermore, the progressive increase in the average life allow the forecast of a strong increase in people with motor impairments, mostly due to the greater aging of the population, the greater incidence of chronic diseases as well as road accidents.

Therefore, the demand for vehicles and aids intended for the mobility of people with motor impairments, such as electric wheelchairs, will become increasingly heard.

This type of vehicle is fundamentally important for making people with motor impairments autonomous and capable of reaching any place, even on difficult or uphill routes, without the need of being accompanied.

Currently, most electric wheelchairs use lead batteries (AGM or gel) for their operation.

The charging of these batteries necessarily takes place by connecting to the domestic electricity network (230V), via a normal domestic socket (example of the ‘Schuko’ type).

Disadvantageously, this method provides for long charging times, therefore it reduces the possibility for people with motor impairments to use the electric wheelchair for a period of time that is not negligible, preventing his movement.

Unfortunately, currently, no known electric wheelchair supports a fast charging mode.

In addition, for the charging of electric wheelchairs, the connection to the domestic electricity network is provided, making it necessary to carefully plan movements, which therefore cannot involve excessively long routes.

### SUMMARY OF THE INVENTION

The technical problem posed and solved by the present invention is therefore to provide a device which allows to overcome the above-mentioned drawbacks with reference to the prior art.

The aforementioned drawbacks are solved by a connection device to be permanently installed on-board with respect to an independent electric wheelchair according to claim 1, as well as by an electric wheelchair comprising the aforementioned connection device installed on-board according to independent claim 15.

Preferred features of the present invention are the subject of the dependent claims.

The aim of the invention is to provide a connection device fixed on-board with respect to an electric wheelchair, designed and configured to allow the relative traction battery to be recharged by means of a charging station or column for electric vehicles which adopts the mode 3 of charging according to IEC 61851-1 and of the type already present on the territory at an international level, obtaining a higher level of electrical safety compared to domestic charging during the charging phase due indeed to the adoption of the mode 3 of charging established in the IEC 61851-1 standard.

The invention allows to overcome the current limits of the electric charging infrastructure towards electric vehicles destined for users with special needs.

The invention therefore provides a connection device fixed on-board with respect to an electric wheelchair, equipped with:
a. An electrical socket for the charger plug of the electric wheelchair;
b. A control and security electrical circuit (named “simplified pilot”), configured to simulate the performance of an electric vehicle during the mode 3 of charging from the 61851-1 standard, precisely realized compliant with what is stated by the aforementioned IEC 61851-1 standard, edition 3, Annex 1, chapter A.2.3, which defines the international reference standard of the field (the circuit in question is shown in FIG. 2, which reproduces what defined within the aforementioned standard).
c. An IEC 61851-1 mode 3 charging cable with one of the two connection terminals attached to the same connection device of the electric wheelchair and the other mobile equipped with its type3a/type2 plug to be connected to the charging station or column.

A further asset of the implemented solution is the high level of electrical safety that the invention inherits from the mode 3 of charging from the IEC 61851-1 standard which allows recharging with the charging infrastructures for electric vehicles in the area, obtaining a higher level of safety compared to a recharge carried out via a classic domestic socket.

Allowing electric wheelchairs to be recharged with such a degree of electrical safety through the charging infrastructures for electric vehicles already present and distributed in the area, further represents a chance for users with impairments to increase the perception of the safety of their own transport system.

The opportunity to use the public charging network for electric vehicles is advantageous, for example, during a long journey, when there is no opportunity to connect to the domestic network. Furthermore, this option is particularly advantageous in the event of emergency, and ensures greater independence of the person with special needs who uses an electric aid for his mobility.

Advantageously, the present invention provides people with impairments with a solution for using electric wheelchairs in complete autonomy and high electrical safety. The availability of reliable and widespread charging infrastructures in the area allows the user with special needs to enjoy greater freedom and independence in his movement.

The invention was conceived to promote the development of a civil society more inclusive and supportive for people with motor impairments, in accordance with the ‘Sustainable Development Goals’ promoted by the United Nations Organization.

Other advantages, characteristics and methods of use of the present invention will become apparent from the following detailed description of several embodiments, presented by way of non-limiting examples.

The invention provides the presence of an anti-tamper/alarm system which detects when the on-board connection device attached to the electric wheelchair (1) is removed from the chair itself. This anti-tamper system will disable the operation of the aforementioned connection device (1) in order not to allow third parties (other than the specific assignee user of the electric wheelchair) to make an improper or promiscuous use of the invention. This anti-tamper system can be integrated to the circuit (10) or to the mechanics of the connection device attached to the wheelchair (1) and can be realized through mechanical, electromechanical, electronic solutions with exchange of authentication software keys and wireless technologies with client authentication codes.

### BRIEF DESCRIPTION OF THE DRAWINGS

Reference will be made to the attached figures, wherein:

FIG. 1 shows a preferred embodiment of a connection device attached to the wheelchair according to the present invention;

FIG. 2 shows an electrical circuit included in the connection device attached to the wheelchair of FIG. 1 and configured to allow interaction with the charging station for electric vehicles, in accordance with IEC 61851-1, edition 3, Annex 1, chapter A.2.3; is

FIG. 3 shows the connection between an electrical circuit of a charge station of electric vehicles and an electrical circuit for simulating the performance of an electric vehicle (the latter already shown in FIG. 2), both circuits and their connection being defined in accordance with IEC 61851-1, edition 3, Annex 1, chapter A.2.3.

The above indicated figures are to be intended only as an example and not for limiting purposes.

### DETAILED DESCRIPTION OF PREFERRED EMBODIMENTS

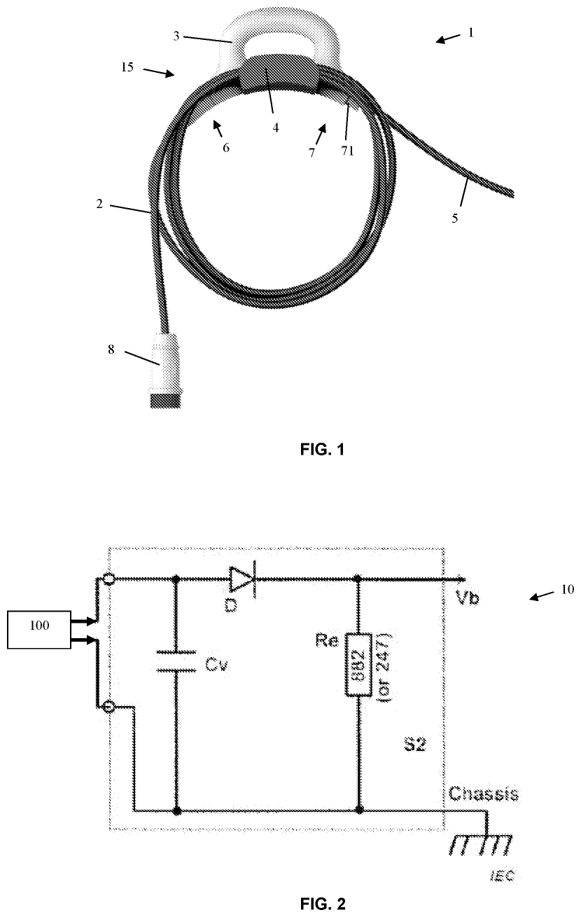

With reference to FIG. 1, a preferred embodiment of a connection device attached to the wheelchair according to the present invention is overall denoted by 1.

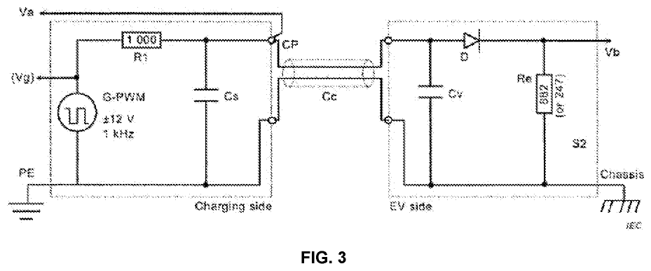

The connection device attached to the wheelchair 1 is configured to allow the charging of an electric wheelchair by connection to a charge station, or column, for electric vehicles, configured compliant with the international standard defined by IEC 61851-1 standard, edition 3, Annex 1, chapter A.2.3. The charge station circuit to which the connection device attached to the wheelchair 1 according to the present invention can be connected is shown in FIG. 3, left portion named as “Charging side”, which reproduces what is defined in the standard above mentioned.

For this purpose, the connection device attached to the wheelchair 1 comprises, or is configured to be connected to, a first wire portion 2 for the electrical connection to the charge station.

The connection device attached to the wheelchair 1 of the invention comprises a main body 15 preferably bearing a first end 6 and a second end 7, even more preferably opposite to each other.

The main body 15 is connected, or configured to be connected, to the aforementioned first wire portion 2 at its first end 6.

At a loose terminal end of the first wire portion 2, connection means 8 is preferably provided for the electrical connection to the charge station, preferably comprising a plug of ‘Type 3A/Type 2’ using the mode 3 of charging.

The main body 15 includes an electrical circuit 10 configured to simulate the performance of an electric vehicle, in particular a simplified pilot circuit, defined according to what is shown in FIG. 2.

Circuit 10 is configured compliance with the international standard defined by the standard IEC 61851-1, edition 3, Annex 1, chapter A.2.3.

The aforementioned circuit 10 comprises two main circuit branches, on one of which there is a diode D in series with a resistance Re as indicated within the aforementioned IEC 61851-1 standard. Parallel to the latter there is a capacitor Cv.

The circuit 10 operation is preserved by the presence of a fuse, which is placed in order to electrically protect the connection device attached to the wheelchair—and the electric wheelchair associated therewith—from any overcurrents. In particular, the fuse is configured to avoid a current consumption higher than 2 A by the connection device attached to the wheelchair according to the invention.

In such case, the connection device attached to the wheelchair becomes inoperable (except for the replacement of the fuse), because the passage of current is prevented.

Further referring to FIG. 1, the main body 15 also comprises, preferably at the second end 7, connection means 71 to a second wire portion 5 for the electrical connection to an electric wheelchair. Said second wire portion 5 can be integrated in the wheelchair itself, or it can be alternatively included in the connection device attached to the wheelchair 1. According to a preferred variant of the invention, the connection means 71 can comprise a ‘Shuko’ socket.

According to this configuration, during use, the main body 15 is interposed between the aforementioned first and second portions of cable 2, 5.

Preferably, the main body 15 comprises a handle member 3 for the manipulation of the connection device attached to the wheelchair 1 by a user. Even more preferably, the main body 15 comprises a further hook member 4, more generally a member with a conformation at least partially curved, configured in such a way as to allow the aforementioned first wire portion 2 to be rolled up thereon to facilitate transport and the repositioning of the connection device attached to the wheelchair 1 in case of non-use. Even more preferably, the configuration of the connection device attached to the wheelchair 1 is such that the handle member 3 is interposed between the aforementioned first and second ends 6, 7 of the main body 15.

In particular, the configuration of the main body 15 can be overall as a ‘D’, wherein the handle member 3 corresponds to the curved branch of the ‘D’, while the first and second ends 6, 7 are arranged at the terminal ends of the straight branch of the ‘D’, and wherein preferably the hook member 4 is interposed between the aforementioned first and second ends 6, 7.

The present invention has been hitherto described with reference to preferred embodiments. It is to be understood that other embodiments may exist that belong to the same inventive core, as defined by the scope of protection of the claims set forth below.

1. Connection device attached to a wheelchair for charging an electric wheelchair by connection to a charge station for electric vehicles, said charge station being realized compliant with what stated by IEC 61851-1 standard, edition 3, Annex 1, chapter A.2.3,
said connection device attached to the wheelchair comprising a main body bearing a first end and a second end preferably opposite to each other,
said main body being configured to be connected at said first end to a first wire portion, said first wire portion being configured for the electrical connection to the charge station,
wherein said main body comprises an electrical circuit configured to simulate performance of an electric vehicle and defined compliant with the IEC 61851-1 standard, edition 3, Annex 1, chapter A.2.3.

2. Connection device attached to the wheelchair according to claim 1, comprising said first wire portion.

3. Connection device attached to the wheelchair according to claim 2, comprising, at a loose terminal end of said first wire portion, connection means configured for the electrical connection to the charge station.

4. Connection device attached to the wheelchair according to claim 3, wherein said connection means comprises a plug of a ‘Type 3A/Type 2’ using mode 3 of charging IEC 61851-1.

5. On-board device connector united to the wheelchair according to claim 1, wherein said main body further comprises, at said second end, connection means comprising a domestic socket (such as ‘Shuko’ type).

6. Connection device attached to the wheelchair according to claim 5, having a configuration such that, during use, said main body results to be interposed between said first wire portion and said second wire portion united to a charger of the wheelchair.

7. Connection device attached to the wheelchair according to claim 1, wherein said main body comprises a handle member.

8. Connection device attached to the wheelchair according to claim 7, having a configuration such that said handle member is interposed between said first end and said second end.

9. Connection device attached to the wheelchair according to claim 1, wherein said main body comprises a member with a conformation at least partially curved, configured in such a way as to allow to roll up said first wire portion thereon.

10. Connection device attached to the wheelchair according to claim 9, wherein said member with a conformation at least partially curved is a member shaped as a hook.

11. Connection device attached to the wheelchair according to claim 7, wherein said main body has an overall conformation as a ‘D’, wherein said handle member corresponds to a curved branch of the ‘D’, while said first and second ends are arranged at a terminal end of a straight branch of the ‘D’, and wherein preferably a hook member is interposed between said first and second ends.

12. Connection device attached to the wheelchair according to claim 1, wherein said electrical circuit comprises a fuse configured to avoid a current consumption higher than 2 A.

13. Electric wheelchair comprising a connection device attached to the wheelchair according to claim 1.
